(19) United States
(12) Patent Application Publication
(10) Pub. No.: US 2023/0256783 A1
(43) Pub. Date: Aug. 17, 2023

(54) Receiver Hitch Adapter

(71) Applicant: Kuat Innovations LLC, Springfield, MO (US)

(72) Inventor: Luke Kuschmeader, Springfield, MO (US)

(73) Assignee: Kuat Innovations LLC, Springfield, MO (US)

(21) Appl. No.: 17/669,487

(22) Filed: Feb. 11, 2022

(51) Int. Cl. B60D 1/24; F16B 7/00

(52) U.S. Cl. CPC B60D 1/24; F16B 7/00; F16B 2001/0035

(57) ABSTRACT

A receiver hitch adapter is described for allowing the receiver hitch to receive several different sizes of receiver tubes or drawbars. The receiver hitch adapter allows the use of receiver tubes that have expansion type clamps such as corner expansion clamps or travelling wedges. The receiver hitch adapter is easily removable from the receiver hitch when not in use, but also remains in place during installation and removal without the user holding it in place.

### CROSS-REFERENCES TO RELATED APPLICATIONS

None.

### BACKGROUND

### Field of the Invention

This disclosure is in the field of receiver hitches for vehicles. More specifically, this disclosure is in the field of adapters for use with receiver hitches.

### Description of the Related Art

Receiver hitch mechanisms are commonly used to allow a variety of accessories to be interchangeably attached to the rear of a vehicle. These include trailers, cargo carriers, and various sizes of bicycle racks, among other types of accessories. A receiver hitch tube is typically attached to a vehicle in a semi-permanent fashion by bolting or welding the tube to the frame of the vehicle. An accessory tube, sometimes referred to as a drawbar, that is sized to fit the receiver hitch tube is inserted into it and secured in place by a clamp mechanism, a bolt, a cross pin, or some other similar mechanism.

The accessory tube is typically sized based on the weight of the accessory to which the accessory tube is attached. For example, a small bicycle rack may be attached to a 1¼ inch wide accessory tube while a larger bicycle rack or a small trailer may be attached to a 2 inch wide accessory tube or drawbar. Vehicles intended to tow trailers of larger trailer weight or tongue weight may be provided with a receiver tube that is 2½ inches or 3 inches in width.

A larger vehicle will typically have a receiver hitch sized for the largest accessory that the vehicle can support. However, the user of the vehicle may want to utilize accessories made for use with smaller receiver hitch tubes. Adapters for inserting a smaller accessory tube into an oversized receiver hitch tube may be used for smaller accessories. Multiple different sizes of adapters are required for each combination of receiver hitch and accessory tube that will be used together.

In some cases, these adaptors may bolt or attach to the accessory tube. This type of attachment interferes with or reduces the effectiveness of clamping mechanisms that expand outward to press on the inside of the receiver hitch tube. It also interferes with use of the accessory on other vehicles that don't have the larger receiver tube dimension. In other cases, the adaptors may attach to the receiver tube which requires use of a separate permanent attachment mechanism to hold the adapter in place in addition to the internal clamping mechanism.

### SUMMARY OF THE INVENTION

In various embodiments,

### BRIEF DESCRIPTION OF THE DRAWINGS

FIG. 1 is a perspective view of embodiments of the inventive receiver hitch adapter in use with a receiver hitch and an accessory tube.

FIG. 2A is a perspective view of an embodiment of the inventive receiver hitch adapter.

FIG. 2B is a side plan view of an embodiment of the inventive receiver hitch adapter.

FIG. 2C is an end plan view of an embodiment of the inventive receiver hitch adapter.

FIG. 3 is a perspective view of embodiments of the inventive receiver hitch adapter installed in a receiver hitch tube.

FIG. 4 is a cross-sectional view of embodiments of the inventive receiver hitch adapter in use with a receiver hitch and accessory tube.

### DETAILED DESCRIPTION

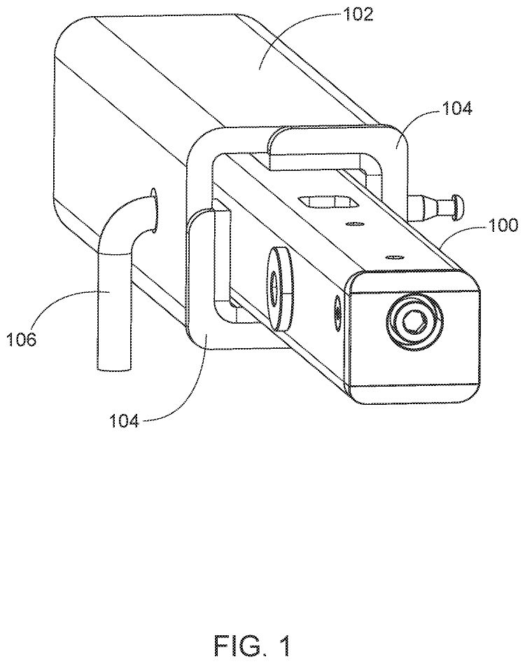

Referring now to FIG. 1, a perspective view of two embodiments of the inventive receiver hitch adapter in use with a receiver hitch 102 and an accessory tube or draw bar 100. The accessory tube 100 is a tube used to mount bicycle racks, cargo carriers, and other accessories onto a vehicle, or to attach a trailer or other towable vehicle to the receiver hitch 102. A cross pin 106 is shown for securing the drawbar 100 in the receiver hitch 102 from theft. The accessory tubes 100 are substantially square in cross-section and have one of several standard widths. These widths typically are selected from the following sizes: 1¼ inch, 2 inch, 2½ inch, and 3 inch although the dimensions of the receiver hitch or the accessory tube are not limiting of the inventive device. They may be slightly smaller than the nominal standard width to provide for easier insertion into a receiver hitch tube 102. The size of the accessory tube width is commonly selected to provide enough strength to carry the weight of the attachment and any equipment loaded thereon, but not larger than necessary to save expense and weight.

In FIG. 1, two embodiments of the inventive adapter 104 are depicted in use to secure a 2-inch accessory tube 100 in a 2.5-inch receiver hitch 102. In the depicted usage, the two adapters 104 are placed on opposite interior corners of the receiver hitch 102. In some embodiments of the inventive device, one or both adapters 104 may be provided with a magnet or other securing means for releasably holding them in place while the accessory tube is inserted into the hitch. In the depicted embodiment, a magnet 104c is attached to the outer surface of the plate 104a. In a preferred embodiment the magnet 104c is recessed into the plate 104a or 104b so that the outer surface of the magnet 104c is flush with the outer surface of the plate 104a or 104b. The accessory tube 100 is then placed between the adapters 104. If the accessory tube 100 is provided with a clamping mechanism in addition to the cross pin 106 it may then be tightened to secure the accessory tube 100 in place in the receiver hitch 102.

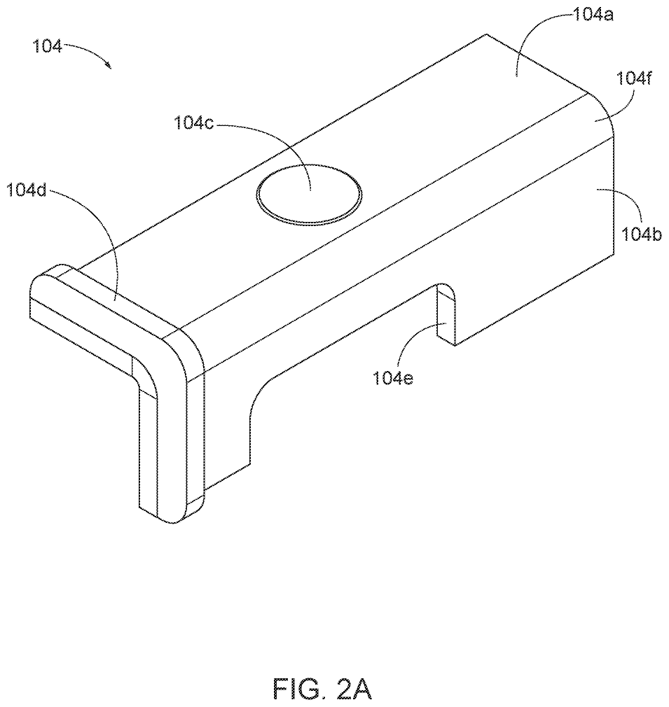

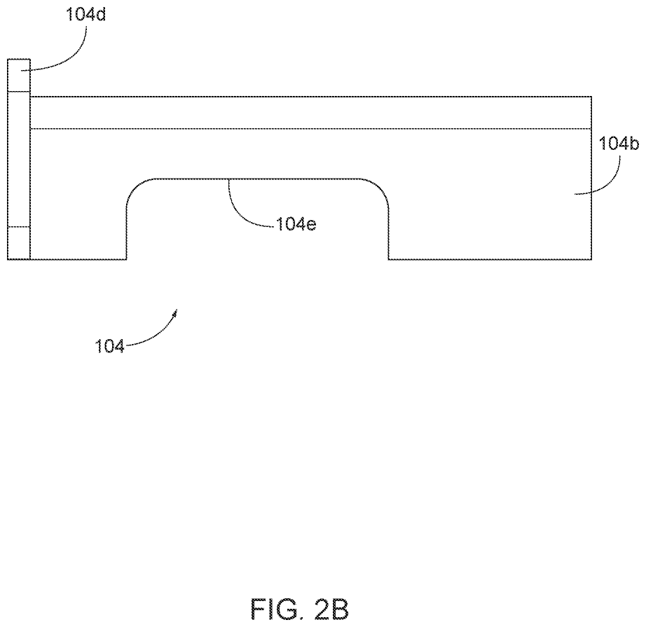

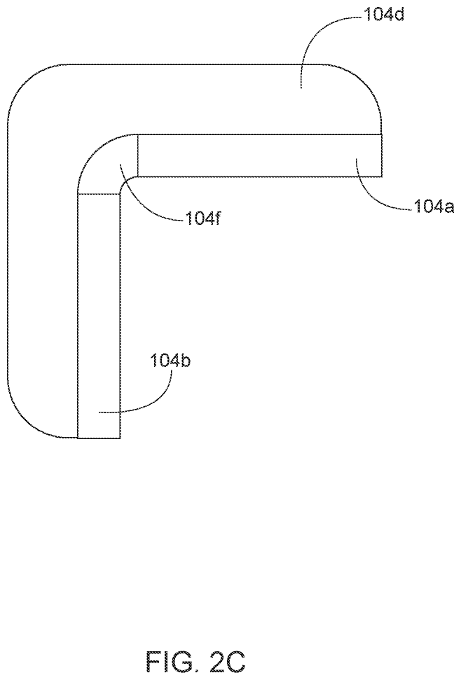

Referring now to FIGS. 2A, 2B, and 2C, perspective, side plan, and end plan views of an embodiment of the receiver hitch adapter 104 are depicted, respectively. The depicted embodiment comprises a top or bottom plate 104a, a side plate 104b, and a tab or flange 104d. The plate 104a and the plate 104b are attached along a first edge 104f and are disposed substantially perpendicular to each other along that edge. The depicted embodiment is also provided with a chamfered edge on outside corner 104f between the plates 104a and 104b to reduce constriction or interference between the adapter 104 and the interior corner of the receiver hitch 102 which may have obstructions that would interfere with a sharper corner, such as weld beads, dirt, paint, or other protrusions.

In using the depicted embodiment, the top/bottom plate 104a is positioned against the interior top or bottom surface of the receiver hitch 102 and the side plate 104b is placed against one or other of the interior side surfaces of the receiver hitch 102. The tab or flange 104d is positioned against the outer surface of the end of the receiver hitch tube 102. In varying embodiments, the tab or flange 104d may be positioned at one end of the plates 104a and 104b or along their length so that they extend out from the receiver hitch when installed. In other embodiments the tab or flange 104d may extend only along the width of plate 104a or 104b but not both. In a preferred embodiment the tab or flange extends substantially outwardly from an edge of the top/bottom plates 104a and side plates 104b and is substantially perpendicular to the plates 104a and 104b.

In various embodiments the tab or flange 104d positions the adapter device at the proper position to align the aperture 104e with the hole 102b, and to prevent the adapter from sliding too far into the receiver hitch tube 102.

The depicted embodiment also has an attachment mechanism 104c to releasably attach the adapter to the receiver hitch 102. In the depicted embodiment the attachment mechanism comprises a magnet 104c that is permanently attached to the adaptor 104. The magnet in these embodiments is selected to provide sufficient force to hold the adapter 104 in place but to allow a user to remove the adaptor 104 from the tube 102 without the use of tools or excessive force.

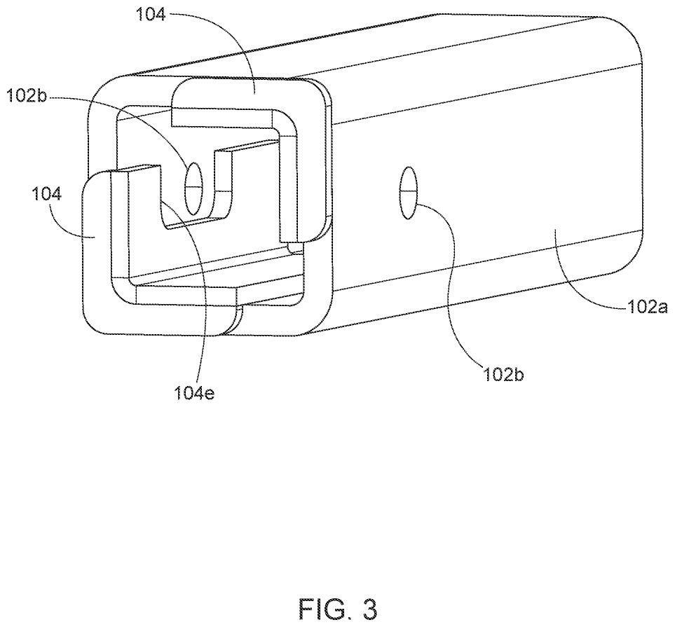

FIG. 3 depicts a perspective view of a receiver tube 102 with two adapters 104 disposed in the tube 102. In some embodiments such as that depicted in the figures, an aperture or cut-out 104e is provided to allow the passage of the cross pin 106 through hole 102b in the tube 102. The aperture 104e may be sized to allow multiple locations of the hole 102b without requiring a different adapter 104.

In a preferred embodiment of the inventive device, the top/bottom and side walls 104a and 104b are narrower in width than the interior width of the receiver hitch tube 102. As can be seen in FIG. 3, the depicted embodiment includes side and top/bottom walls that extend less than all the way across the width of the receiver hitch tube.

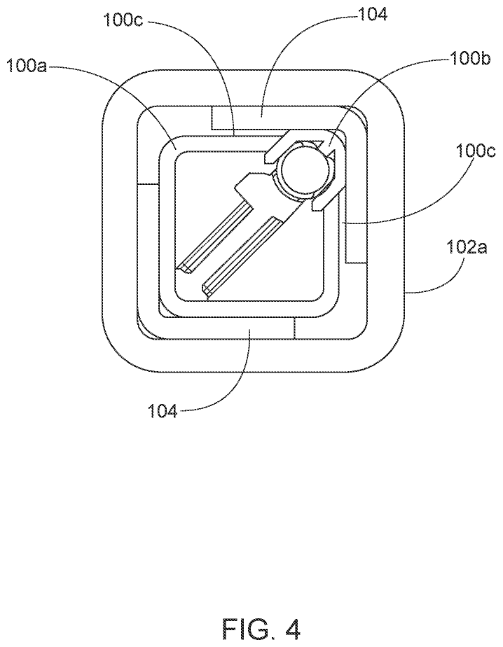

FIG. 4 depicts a cross-sectional view of an embodiment of the adapter 104 in use with receiver hitch tube 102 and an exemplary accessory tube 100a. The accessory tube 100a has an expanding clamp mechanism 100b. The figure depicts the use of the expanding clamp mechanism with the adaptor 104 to secure the accessory tube 100a in place by pressure against both adapters 104. The accessory tube 100a presses against the lower adapter 104 while the clamp mechanism 100b presses against the upper adapter 104. This depicts that the adapters 104 allow expanding clamp mechanisms that would not work with adapters that attach to the accessory tube 100.

FIG. 4 also depicts that the adapters 104 allow the single clamp mechanism used to hold accessory tube 100 in place also hold the adapters 104 in place during use. Other adapters that require separate attachment to the receiver hitch tube 102 are less convenient and secure.

In some embodiments the inventive receiver hitch adapter comprises a first corner member 104f and a second corner member 104f. These corner members 104f may be provided with some adjacent flat portions to fit against the inside surfaces of the hitch tube 102. The corner members may have a tab or flange to abut the end of the receiver hitch tube 102. In some embodiments the tab or flange is positioned at an end of the corner members but in other embodiments the tab or flange may be at a point on the corner members that is spaced apart from either end. A magnet may be provided in the corner member 104f or in the surface adjacent to it. In some embodiments one or more of the corner members or other parts of the receiver hitch adapter may be magnetized themselves and require no additional magnet to be held in place on the receiver hitch tube 102.

“Substantially” means to be more-or-less conforming to the dimension, range, shape, concept, or other aspect modified by the term, such that a feature or component need not conform exactly. For example, a “substantially cylindrical” object means that the object resembles a cylinder but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

1. An adapter for a receiver hitch tube, the adapter comprising:
a first plate and a second plate attached to the first plate along an edge thereof, wherein
the first plate is substantially perpendicular to the second plate;
a tab extending from one end of the first or second plate;
a magnet attached to the first plate or the second plate;
wherein the tab is configured to engage an end of the receiver hitch tube; and
wherein the magnet is configured to magnetically engage the receiver hitch tube.

2. The adapter of claim 1 further comprising an aperture in one of the first or second plate for receiving a cross pin disposed through the receiver hitch tube.

3. An adapter system for a receiver hitch tube, the adapter system comprising:
a first adapter having a top plate and a first side plate, wherein the first side plate is disposed substantially perpendicular to the top plate forming an outside corner, and a first flange attached to an end of the top plate and the first side plate, the first flange extending perpendicularly outwardly from the top plate and the first side plate;
the first adapter having a magnet disposed on the top plate and configured to engage the receiver hitch tube;
a second adapter having a bottom plate and a second side plate, wherein the second side plate is disposed substantially perpendicular to the bottom plate forming a second outside corner, and a second flange attached to an end of the bottom plate and the second side plate, the second flange extending perpendicularly outwardly from the bottom plate and the second side plate;
the second adapter having a second magnet disposed on the bottom plate and configured to engage the receiver hitch tube.

4. An adapter for a receiver hitch tube, the adapter comprising:
a first corner member and a second corner member, each corner member having a tab extending outwardly from the corner member for engaging an end of the receiver hitch tube;
wherein at least one of the first and second corner members is configured to temporarily attach to an inside corner of the receiver hitch tube.

5. The adapter of claim 4 wherein at least a portion of one of the first and second corner members is magnetic.

6. The adapter of claim 5 wherein the first and second corner members are configured to accept a receiver drawbar when disposed in opposed inside corners of the receiver hitch tube.
